(19) United States
(12) Patent Application Publication
(10) Pub. No.: US 2017/0055332 A1
(43) Pub. Date: Feb. 23, 2017

(54) ILLUMINATION SYSTEM

(71) Applicant: ANSORG GMBH, Mülheim an der Ruhr (DE)

(72) Inventor: Otto Flach, Velbert (DE)

(21) Appl. No.: 15/118,697

(22) PCT Filed: Feb. 13, 2015
(86) PCT No.: PCT/EP2015/053168

§ 371 Date: Aug. 12, 2016

(30) Foreign Application Priority Data
Feb. 14, 2014 (DE) 10 2014 202 720.9

(51) Int. Cl. H05B 37/02

(52) U.S. Cl. CPC H05B 37/0272

(57) ABSTRACT

An illumination system includes several controllable lights and a mobile remote control for adjusting illumination properties of the lights, wherein the remote control includes a radio transmitter for transmitting control signals. The lights each have a radio receiver. Control signals sent from the radio transmitter of the remote control are receivable directly by radio receivers of the lights. The lights are controllable by their radio receivers involving the control signals transmitted by the radio transmitter of the remote control. The illuminating properties and/or the radiation characteristics of the lights are adjustable and controllable directly by the remote control in that the radio receivers of the lights receive control signals directly from the remote control and in that the lights are controlled by their radio receivers by the transmitted control signals.

### TECHNICAL FIELD

The invention relates to an illumination system according to the precharacterizing clause of independent claim 1.

Such illumination systems comprising a number of controllable lights and a mobile remote control for adjusting illumination properties of the lights, the remote control having a radio transmitter for transmitting control signals, can be used for efficiently controlling the lights, for example in mercantile stores, in trade fairs or in architecture.

### PRIOR ART

In many applications, a multiplicity of lights are used simultaneously for the illumination of relatively large inside and outside spaces, for example in sales or exhibition rooms, respectively, in trade fairs, in mercantile presentations or in illumination of buildings. For the efficient management of the lights, these are frequently organized in lighting systems at present in which the adjustment of the lights can be effected from an operating unit. For this purpose, such lighting systems typically have a central control unit which is connected to the individual lights via cables. For the communication of the central control unit with the lights, standardized protocols can be used such as, for example, the Digital Addressable Lighting Interface (DALI).

For the adjustment of the lights, the central control unit is usually supplied via a user interface of the operating unit with control commands on the basis of which the control unit adapts the individual lights. For example, illumination properties such as the brightness can be adjusted via the central control unit.

In WO 2013/153097 A1, such an illumination system is described in which in each case groups of ballasts of lights are connected to a central control unit via data lines or wirelessly. The central control units are designed to process control information, which they receive from sensors and an operating element, into control commands. The operating element is designed as a mobile device connected to the central control units by radio. A user can deliver control information to the central control units via a user interface from the operating device.

A disadvantageous factor in the known illumination systems is that before they are taken into operation and possibly also in the case of changing applications, at least one databus line must be installed. This usually requires an expert. Correspondingly, such taking into operation or, respectively, adaptation is relatively expensive which is frequently undesirable.

It is the object of the subsequent invention, therefore, to propose an illumination system which is relatively flexible and can be installed and adapted in a simple manner and operated in a comfortable manner.

### REPRESENTATION OF THE INVENTION

According to the invention, the object is achieved by an illumination system as it is characterized by the features of the independent claim 1. Advantageous embodiments of the illumination system according to the invention are obtained from the features of the dependent claims.

The essence of the invention consists in the following: an illumination system comprises a number of controllable lights and a mobile remote control for adjusting illumination properties of the lights, the remote control having a radio transmitter for transmitting control signals. The lights comprise in each case a radio receiver, wherein control signals transmitted by the radio transmitter of the remote control can be received directly by the radio receivers of the lights. The lights can be controlled in each case by their radio receivers involving the control signals transmitted by the radio transmitter of the remote control.

The controllable lights can be, in particular, LED lights. Such LED lights typically have a light emitting diode as luminant means and can be adjusted in many ways. For example, in the case of LED lights, their colour and brightness can be adjusted relatively flexibly and simply. In addition, LED lights are frequently relatively economical, durable and cost effective. LED lights can be preferred particularly in areas in which a flexible and reliable application is of significance.

The radio receivers of the lights can be designed in each case as ready-made board comprising an antenna, a processor and lines. In this way, the radio receivers can be designed for efficiently receiving the control signals and controlling the lights. In addition, they can have an attachment for their installation at the lights.

The term “illumination properties” can refer, in conjunction with the lights, for example to the colour of the light, the intensity/brightness, the energy consumption, the angle of radiation, the focus and the like.

In connection with the control signals, the term “involving” can refer to the fact that the control signals are involved in controlling the lights. For example, the control signals can be evaluated and the light controlled in accordance with the evaluated control signals.

In connection with the control signals, the term “directly receivable” refers to a direct transmission from the remote control to the lights. A component arranged between the remote control and the lights such as, for example, a central control unit, a router or a bridge, do not exist.

Since the radio receivers of the lights receive control signals directly from the remote control and since the lights are controlled by their radio receivers by means of the transmitted radio signals or control signals, respectively, the illumination properties or radiation characteristics of the lights, respectively, can be adjusted and controlled directly by the remote control. Due to the direct radio links, no additional databus lines are necessary in the object. In this way, the illumination system according to the invention can be attached and adapted in a flexible and simple manner.

In addition, the remote control can be used locally flexibly due to the radio links as a result of which the illumination system can be operable in a comfortable manner.

The remote control and the lights together preferably form a wireless network in which the remote control is configured as master and the lights are configured as slaves. With such a hierarchical management of the access to a common data channel, the control of the lights and the operation of the illumination system can be efficiently guaranteed.

The illumination system preferably comprises an intermediary unit which is included in the wireless network and configured as additional master. Such an additional master can be configured as backup master so that in the case of a failure of the master, continuous operation can be ensured in the network. Alternatively or additionally, the intermediary unit can take over a relay function for signal amplification/forwarding for the lights.

In particular, the additional master can form an intermediate level between the master and the slaves. In this context, the additional master can operate the slaves at least partially even if the master is not located in the network. The intermediary unit can be implemented as “memory” or intermediate control of the illumination system. Thus, certain control functions can be stored in the intermediary unit and transferred from it to the lights. Correspondingly, the intermediary unit can take over certain basic control functions of the lights even if the remote control itself is not in the network.

For example, daytime-dependent control functions such as a call-up of light scenes or sequences can be stored in the intermediary unit. The intermediary unit can then forward corresponding control signals to the lights and thus control the latter.

Or the intermediary unit can be equipped with a digital calendar or a clock, respectively. It can then handle, for example, daytime- or weekday-dependent control functions of the illumination system without the remote control or the master, respectively, having to be located in the wireless network.

The configuration of the intermediary unit can be effected, in particular, also via the remote control. For example, the daytime-dependent control of the lights can be preset on the intermediary unit via the remote control. Thus, the remote control can control and adjust the entire illumination system as master, whereas the intermediary unit can handle intermediate control functions or basic control functions.

The intermediary unit preferably comprises a battery. By this means, continuous operation of the additional master in the wireless network can be ensured. The intermediary unit can thus be supplied autonomously by the power supply so that control of the illumination system can be maintained even with the lights switched off. The intermediary unit also comprises preferably a control command memory. In such a control command memory, control commands for adjusting the lights can be stored.

In a preferred embodiment, the intermediary unit is integrated in one of the lights. This light is then equipped with a radio transmitter, wherein control signals transmitted by the radio transmitter of the remote control can be received directly by the radio receiver of the light with the intermediary unit. In this context, control signals transmitted by the intermediary unit via the radio transmitter of the light via the intermediary unit can be received directly by the radio receivers of the other lights and the other lights can be controlled in each case by their radio receivers, involving the control signals transmitted by the radio transmitter of the light with the intermediary unit. As well, several lights of the illumination system can be provided in each case with an intermediary unit.

In another preferred embodiment, the intermediary unit is designed as independent network device. In this context, the network device has a radio receiver and a radio transmitter, control signals transmitted by the radio transmitter of the remote control can be received directly by the radio receiver of the network device, control signals transmitted by the radio transmitter of the network device can be received directly by the radio receivers of the other lights and the other lights can be controlled in each case by their radio receivers, involving the control signals transmitted by the radio transmitter of the network device.

The wireless network is preferably designed in such a way that a radio link between the radio transmitter of the remote control and the radio receivers of the lights can be established exclusively by an activation of the remote control. Otherwise, there is no radio link. By this means, the wireless network can be designed in a relatively resource-saving and reliable manner.

The illumination system preferably comprises a sensor having a radio receiver for directly receiving control signals transmitted by the radio transmitter of the remote control and having a radio transmitter for transmitting sensor signals, wherein the sensor signals transmitted by the radio transmitter of the sensor can be received directly by the radio receiver of at least one of the lights and wherein the at least one of the lights can be controlled by its radio receiver involving the control signals transmitted by the radio transmitter of the sensor. Since the sensor can receive control signals from the remote control, it can be adjusted from the remote control. In particular, it can thus be provided for controlling the associated light or the associated group of lights in accordance with a measured parameter. In the case of a changing measured parameter, the illumination properties of the light(s) can thus be automatically adapted without a new control signal having to be transmitted by the remote control. The one sensor or also several sensors can be comprised by the wireless network and configured, for example, as slaves. For example, the sensor can be a brightness sensor which determines the environmental brightness, a daylight sensor or a presence indicator. For example, such an embodiment of the illumination system enables the illumination to be demand-controlled in an automated manner. In this context, the illumination can be adapted in presence or depending on environmental brightness.

Preferably, the lights have in each case a driver with an interface, wherein the lights can be controlled in each case by their radio receivers via the interface of their drivers. The driver can be, in particular, an LED driver. Such control via the interface of the driver of the light enables the illumination properties of the light to be efficiently adjusted.

In this context, the interfaces of the drivers of the lights are preferably 1-10V interfaces, DALI interfaces or pulse width modulation interfaces. In this context, the abbreviation DALI stands for “Digital Addressable Lighting Interface” and is related to a protocol used, for example, in the automation of buildings, for controlling illumination-related operating devices such as, for example, switched-mode power supplies, electronic ballasts (EVG) or electronic power dimmers. In the illumination system, several different types of interfaces can also be provided. Such interfaces provide for a simple and proven access to the lights so that their illumination properties can be adjusted efficiently.

The remote control preferably has a processor, a data memory and a main memory, wherein the remote control is programmed in such a way that the control signals can be generated in the remote control in accordance with the illumination properties of the lights to be adjusted. Such a remote control can be, for example, a smartphone, a laptop computer or a tablet computer. On the remote control, an operating system can be executed which has an application programming interface (API).

Via this API, the remote control can be programmed efficiently, for example by executing a computer program.

In this context, the remote control preferably comprises a graphical user interface and a user input means for the input of a control command by a user, wherein the remote control is programmed in such a way that the control signals can be generated by the remote control involving a control command input by the user.

The graphical user interface can be, for example, a presentation on a screen. This is known, for example, from applications on tablet computers and smartphones. As user input means, knobs and controllers on the remote control can be provided. In particular, these can be implemented virtually in the graphical user interface and they are operated via contacts on the screen (touch screen).

In this context, the remote control is preferably programmed in such a way that among the number of lights, groups can be formed, the illumination properties of a group of lights being jointly adjustable. Such an allocation of the lights to groups provides for a simplified operation, or a common control, respectively, especially in relatively complex illumination systems.

The remote control is then preferably programmed in such a way that light scenes can be stored and selected in the data memory, the illumination properties of the lights being adjustable in accordance with a selected light scene. In this way, preset scenarios can be efficiently adjusted which can increase the operating comfort of the illumination system further.

The radio transmitter of the remote control is preferably a Bluetooth transmitter and the radio receivers of the lights are preferably a Bluetooth receivers. A radio transmitter of the sensor can also be a Bluetooth transmitter and the radio receiver of the sensor can be a Bluetooth receiver. In this context, the term “Bluetooth” is understood to be an industrial standard developed by the Bluetooth Special Interest Group (SIG) according to IEEE 802.15.1 for the data transmission between devices over a relatively short distance by radio technology. In this context, connectionless transmissions and transmissions with connections from point to point and ad hoc or piconetworks are possible.

By means of a Bluetooth radio technology, an appropriate data rate and an adequate range can be ensured. The transmission rate can also be sufficiently high so that no visual time delay is perceptible between transmitting the control signals and controlling the lights. In addition, Bluetooth radio technologies can be relatively stable, usable without license, globally applicable and reliable. Furthermore, risk of being affected by radio systems operated in parallel can be minimized by means of the Bluetooth radio technology. Finally, a Bluetooth radio network also provides for no additional network components having to be used.

### BRIEF DESCRIPTION OF THE DRAWINGS

Further advantageous embodiments of the invention are obtained from the subsequent description of illustrative embodiments of the invention with the aid of the diagrammatic drawing. In particular, the illumination system according to the invention will be described in greater detail by means of illustrative embodiments with reference to the attached drawing, in which

FIG. 1 shows a diagrammatic representation of an illustrative embodiment of an illumination system according to the invention.

### APPROACH(ES) FOR CARRYING OUT THE INVENTION

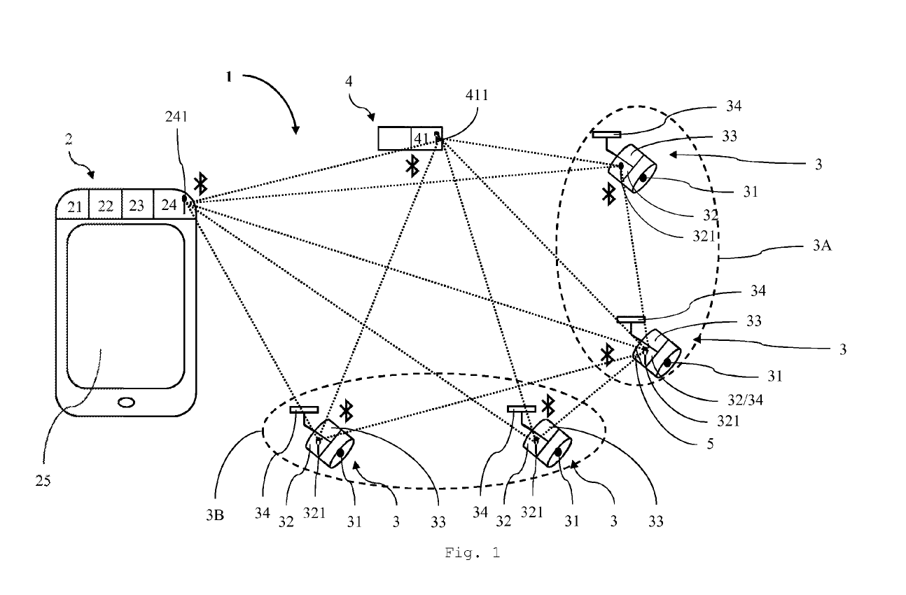

FIG. 1 shows an illustrative embodiment of an illumination system 1 according to the invention, having a number of LED spotlights 3 as controllable lights, a tablet 2 as mobile remote control and a brightness sensor 4 as sensor. The tablet 2 is a conventional tablet computer having a central processing unit (CPU) 21 as processor, a random access memory (RAM) 22 as main memory, a data memory 23 and a touch-sensitive screen or touchscreen 25, respectively, as graphical user interface and user input means. The tablet 2 also comprises a Bluetooth radio transceiver 24 with an antenna 241.

Each of the LED spotlights 3 is equipped with a light-emitting diode 31 as illuminant, a Bluetooth radio receiver 32 with an antenna 321 and an LED driver with a 1-10V interface 33. In addition, the LED spotlights 3 have in each case a holder 34 via which they can be attached to a current rail, for example at a ceiling. The brightness sensor 4 has a Bluetooth radio transceiver with an antenna 411.

The tablet 2, the LED spotlights 3 and the brightness sensor 4 form nodes of a point-to-point radio network as wireless network, the tablet 2 being configured as master and the LED spotlights 3 and the brightness sensor 4 as slaves. The point-to-point network is designed in such a way that a radio link is established only when a signal is transmitted. This means that the network becomes active only when a signal is actively triggered. Otherwise, the network is not active.

On the tablet 2, an operating system is running such as, for example, the operating system iOS of the Apple Inc. company or the Android operating system of the Open Handset Alliance which has an application programming interface (API). Furthermore, a specific light control software is installed on the tablet 2 which, if necessary, is started and executed by a user. By means of the light control software, the tablet 2 is programmed in such a way that a user can perform adjustments on the LED spotlights 3 on the touchscreen 25 or input a control command, respectively. From the user inputs or control commands, respectively, the tablet 2 generates control signals corresponding to the illumination properties to be adjusted, which are sent directly to the Bluetooth radio receivers 32 of the LED spotlights 3 by the Bluetooth radio transceiver. The Bluetooth radio receivers 32 of the LED spotlights 3 control the associated LED spotlight 3, involving the control signals via the 1-10V interface 33 so that the illumination properties of the associated LED spotlight 3 are suitably adjusted.

Furthermore, the tablet 2 is programmed by means of the light control software in such a way that groups 3A, 3B of LED spotlights 3 can be formed. In this way, the illumination properties of all LED spotlights 3 of a group 3A, 3B can be adjusted together. For example, the LED spotlights 3 of group 3A can be adjusted for radiating red light and those of group 3B for yellow light.

The tablet 2 is also programmed by means of the light control software in such a way that light scenes can be stored in the data memory 23 and selected on the touchscreen 25. In this context, the illumination properties of the LED spotlights 3 are adjustable in accordance with a selected light scene.

In addition, the tablet 2 is programmed by means of the light control software in such a way that adjustments can be carried out at the brightness sensor 4. For this purpose, the user performs the adjustments on the touchscreen 25, the light control software generates from these a control signal and the Bluetooth radio transceiver 24 of the tablet 2 sends the control signal directly to the Bluetooth radio transceiver 41 of the brightness sensor 4. The brightness sensor 4 measures the brightness and, in the case of a measured brightness deviating from a target brightness, it generates a sensor signal. The brightness sensor 4 sends this sensor signal via its Bluetooth radio transceiver 41 directly to the Bluetooth radio receivers 32 of the LED spotlights 3. The Bluetooth radio receivers 32 then control the illumination properties of the associated LED spotlight 3, involving the sensor signal via the 1-10V interface 33.

One of the LED spotlights 3, the lower one of the LED spotlights 3 of group 3A in FIG. 1, is equipped with an intermediary unit 5. The intermediary unit 5 comprises a control signal data memory and a battery for its autonomous power supply. The intermediary unit 5 can be preset by the tablet 2 via the radio receiver 32 of the associated LED spotlight 3. The intermediary unit 5 is used as memory in the illumination system 1. It is provided with a calendar and a clock. Via the tablet 2, diurnal and weekday-dependent adjustments of the LED spotlights 3 or the groups of lights 3A, 3B, respectively, can be adjusted. The intermediary unit 5 then sends corresponding control signals via a radio transmitter 34 of the associated LED spotlight 3 to the radio receivers 32 of the other LED spotlights 3. The illumination system 1 can thus be controlled in automated and preset manner by means of the intermediary unit 5.

Although the invention is shown and described in detail by means of the figures and the associated description, this presentation and this detailed description should be understood to be illustrative and exemplary and not as restricting the invention. Naturally, experts can carry out changes and deviations without departing from the scope of the claims following. For example, the invention can also be implemented by the following further constructive variations:
The illumination system can be equipped with a plurality of sensors.
The sensors can be suitable sensors such as, for example motion sensors or daylight sensors.
The sensor can also send the sensor signals only to a selected part of the lights such as, for example, a group of lights.
Instead of an embodiment integrated into one of the lights, the intermediary unit can be designed as independent network device. Or the intermediary unit can also be integrated in the brightness sensor.
The lights of the illumination system can also be equipped with a radio transmitter. Thus, information of the lights can be sent to the remote control, to the intermediary unit or to other lights. For example, a brightness status or dimming value, respectively, can thus be transmitted to the remote control.

The present disclosure also comprises embodiments having any combination of features which have been mentioned or shown previously or subsequently for different embodiments. It also comprises individual features in the figures even if they are shown there in conjunction with other features and/or are not mentioned before or subsequently. As well, the alternatives of embodiments described in the figures and the description, and individual alternatives of their features, can be excluded from the subject matter of the invention or the disclosed subject matters, respectively. The disclosure comprises embodiments which exclusively comprise the features described in the claims or in the illustrative embodiments, respectively, and those which comprise additional other features.

Furthermore, the expression “comprise” and deviations therefrom do not exclude other elements or steps. As well, the indefinite article “a” or “an” and deviations therefrom does not exclude a multiplicity. The functions of a number of features listed in the claims can be met by one unit or one step, respectively. The terms “essentially”, “about”, “approximately” and the like in conjunction with a characteristic or a value, respectively, in particular, also define precisely the characteristic or precisely the value, respectively. The terms “about” and “approximately” in conjunction with a given numerical value or range can relate to a value or range which is within 20%, within 10%, within 5% or within 2% of the given value or range, respectively. A computer program can be stored and/or sold on any suitable medium, such as, for example, on an optical storage medium or a hard medium which is provided together with or as part of other hardware. It can also be sold in another form such as, for example, via the internet or other cabled or un-cabled telecommunication systems. In particular, a computer program can be, for example, a computer program product stored on a computer-readable medium which is designed to be executed for implementing a method. All the reference symbols in the claims are not to be understood as restricting the scope of the claims.

1. An illumination system comprising a number of controllable lights and a mobile remote control for adjusting illumination properties of the lights, the remote control having a radio transmitter for transmitting control signals, wherein
the lights in each case comprise a radio receiver,
control signals transmitted by the radio transmitter of the remote control receivable directly by radio receivers of the lights, and
the lights controllable by their radio receivers involving the control signals transmitted by the radio transmitter of the remote control.

2. The illumination system according to claim 1, wherein the remote control and the lights together form a wireless network in which the remote control is configured as master and the lights are configured as slaves.

3. The illumination system according to claim 2, wherein the wireless network comprises an intermediary unit that is configured as an additional master.

4. The illumination system according to claim 3, wherein the intermediary unit comprises a battery.

5. The illumination system according to claim 3, wherein the intermediary unit comprises a control command memory.

6. The illumination system according to claim 3, wherein the intermediary unit is integrated into one of the lights which is equipped with a radio transmitter, wherein
control signals transmitted by the radio transmitter of the remote control are receivable directly by the radio receiver of the light with the intermediary unit,
control signals transmitted by the intermediary unit via the radio transmitter of the light with the intermediary unit can is receivable directly by the radio receivers of other lights, and
the other lights are controllable by their radio receivers, involving the control signals transmitted by the radio transmitter of the light with the intermediary unit.

7. The illumination system according to claim 3, wherein the intermediary unit is designed as an independent network device, wherein
the network device has a radio receiver and a radio transmitter,
control signals transmitted by the radio transmitter of the remote control are receivable directly by the radio receiver of the network device,
control signals transmitted by the radio transmitter of the network device are receivable directly by the radio receivers of other lights, and
the other lights are controllable by their radio receivers, involving the control signals transmitted by the radio transmitter of the network device.

8. The illumination system according to claim 2, wherein the wireless network is designed in such a way that a radio link between the radio transmitter of the remote control and the radio receivers of the lights is enabled to be established exclusively by an activation of the remote control.

9. The illumination system according to claim 1, the system comprising a sensor having a radio receiver for to directly receive control signals transmitted by the radio transmitter of the remote control, and a radio transmitter to transmit sensor signals, wherein the sensor signals transmitted by the radio transmitter of the sensor are receivable directly by the radio receiver of at least one of the lights and wherein the at least one of the lights is controllable by its radio receiver involving the sensor signals transmitted by the radio transmitter of the sensor.

10. The illumination system according to claim 1, wherein the lights have in each case a driver with an interface, wherein the lights are controllable by their radio receivers via interfaces of their drivers.

11. The illumination system according to claim 10, wherein the interfaces of the drivers of the lights are 1V-10V interfaces, DALI interfaces, or pulse width modulation interfaces.

12. system according to claim 1, wherein the remote control has a processor, a data memory, and a main memory, wherein the remote control is programmed in such a way that the control signals are enabled to be generated in the remote control in accordance with the illumination properties of the lights to be adjusted.

13. The illumination system according to claim 12, wherein the remote control comprises a graphical user interface and a user input means for the input of a control command by a user, wherein the remote control is programmed in such a way that the control signals are enabled to be generated by the remote control involving the control command input by the user.

14. The illumination system according to claim 12, wherein the remote control is programmed in such a way that among a number of lights groups are enabled to be formed, the illumination properties of a group of lights being jointly adjustable.

15. The illumination system according to claim 13, wherein the remote control is programmed in such a way that light scenes are storable in a data memory and are selectable via the user input means, the illumination properties of the lights being adjustable in accordance with a selected light scene.

16. The illumination system according to claim 1, in which the radio transmitter of the remote control is a Bluetooth transmitter and the radio receivers of the lights are Bluetooth receivers.
